(19) United States
(12) Patent Application Publication
(10) Pub. No.: US 2012/0124372 A1
(43) Pub. Date: May 17, 2012

(54) Protecting Websites and Website Users By Obscuring URLs

(75) Inventors: John A. Dilley, Los Altos, CA (US); Andrew B. Ellis, Medford, MA (US); Stephen L. Ludin, Mill Valley, CA (US); John Summers, Newton, MA (US)

(73) Assignee: AKAMAI TECHNOLOGIES, INC., Cambridge, MA (US)

(21) Appl. No.: 13/272,071

(22) Filed: Oct. 12, 2011

Related U.S. Application Data
(60) Provisional application No. 61/392,823, filed on Oct. 13, 2010.
(60) Provisional application No. 61/504,812, filed on Jul. 6, 2011.

(51) Int. Cl. H04L 29/06

(52) U.S. Cl. 713/162

(57) ABSTRACT

Websites and website users are subject to an increasing array of online threats and attacks. Disclosed herein are, among other things, approaches for protecting websites and website users from online threats. For example, a content server, such as a proxying content delivery network (CDN) server that is delivering content on behalf of an origin server, can modify URLs as they pass through the content server to obscured values that are given to the end-user client browser. The end-user browser can use the obscured URL to obtain content from the content server, but the URL may be valid only for a limited time, and may be invalid for obtaining content from the origin. Hence, information is hidden from the client, making attacks against the website more difficult and frustrating client-end malware that leverages knowledge of browsed URLs.

### REFERENCE TO RELATED APPLICATIONS

This application claims the benefit of priority of U.S. Provisional Application No. 61/392,823, filed Oct. 13, 2010, and of U.S. Provisional Application No. 61/504,812, filed Jul. 6, 2011, the disclosures of both of which are incorporated by reference.

### TECHNICAL FIELD

The present invention generally relates to information security and more particularly to the protection of websites and website users against malware, attack, information theft, and other online threats.

### BACKGROUND

Websites and website users are subject to an increasing array of online threats. Some seek to steal sensitive or confidential information, while others attempt to disrupt the normal operation of a site. Among the many kinds of threats are Distributed Denial of Service (DDoS) attacks, which generate a load to an origin database or application server and may be coordinated with existing botnet command and control systems. Other threats include URL enumeration or Predictable Resource Location attacks, which spider a site to harvest sensitive information embedded in the URL structure, such as catalog part numbers or flight numbers, application server session identifiers, user names or other resources. In some cases, if a site allows username or other sensitive information to be specified in a URL and returns a different response for valid and invalid inputs, an attacker can guess at valid values and harvest information.

Moreover, another security threat has emerged over the past few years that is causing some websites to suffer significant data and financial losses, particularly in the financial service industry. This type of malware attacks browsers by means of Trojan horses. They typically leverage a software plug-in that watches for known URLs and then taking action, such as recording keystrokes or transferring funds from a victim's bank account.

This relatively recent breed of malware can modify a transaction on-the-fly, i.e., as it is formed in the end user's web browser, and still display the user's intended transaction. Structurally, these attacks are referred to as a “man-in-the-middle” (or “man-in-the-browser”, MITB) attack as they live between the user and the security mechanisms of the user's web browser. As noted, such a Trojan operates by infecting the end user's computer and installing a new (malicious) browser extension. The malicious browser extension sets up a page handler that activates on a web page load and looks at the URL of the loaded web page. If the URL is on the list of web pages being targeted by the malware, then the browser extension “wakes up,” intercepts the data that is typed in by the end user, and potentially modifies the data that is sent from the browser to the web server.

Distinct from phishing attacks, which rely upon similar but fraudulent websites, these new attacks often cannot be detected by the user, as they are using real services, the user is correctly logged-in as normal, and there is no difference to be seen.

Such MITB attacks typically target financial institutions and especially business-to-business (B2B) banking, often focusing on money transfer transactions. One variant of the Zeus malware actually changes the destination banking address for money transfers as they are sent from the browser to the bank server while still displaying the desired transfer bank address to the end user in the browser. The impact of these attacks is significant enough that some banks have begun to deploy client software to their customers to attempt to address the problem.

Unfortunately, these are but a few examples of online threats facing today's website operators and users. Moreover, the threat landscape is always evolving, with new breeds of malware and destructive techniques emerging with some frequency.

In the face of this threat landscape, a variety of systems may be used to deliver Internet content to an end user. One approach is to use a distributed computer system such as a “content delivery network” or “CDN” that is operated and managed by a service provider. The service provider typically provides the content delivery service on behalf of third party customers. A “distributed system” of this type typically refers to a collection of autonomous computers linked by a network or networks, together with the software, systems, protocols and techniques designed to facilitate various services, such as website content delivery or the support of outsourced site infrastructure. Typically, such content delivery involves to the storage, caching, or transmission of content, streaming media and applications on behalf of content providers, including ancillary technologies used therewith including, without limitation, DNS query handling, provisioning, data monitoring and reporting, content targeting, personalization, and business intelligence.

In light of the foregoing, there is a need to defend and protect websites, website operators, and website users against an increasingly sophisticated and wide array of online threats. There is further a need to design content delivery systems, including without limitation CDNs, to address these threats. The present invention addresses these needs and other needs that will become apparent in view of this disclosure.

### SUMMARY

An approach referred to herein as URL obfuscation or, alternatively, web application obfuscation (WAO), can provide the ability to protect specific URLs or groups of URLs, as indicated by content providers, from attack. Although the specifics of the implementations may vary, in an exemplary case, this approach operates by detecting when a protected URL passes through a web proxy, for example as a link in a web page. The web proxy (which may be, e.g., a content server in a CDN) replaces that URL with another URL that contains an obfuscated value. Subsequent requests from the client browser back to proxy for the obfuscated URL are then translated back into the original URL format, and the proxy goes forward to an internal cache or to an origin server to request content at the protected URL. In this way, the protected URL is not visible to the client. This means that an attack becomes difficult if not impossible to target or automate for a protected URL. Further, the obfuscation functionality may be configured such that each client session sees a different random URL in place of the protected URL, further frustrating attempts to automate attacks or conduct reconnaissance against a site.

In short, by obscuring an origin URL as it is passed from an origin server to an end user browser, an attack surface of the origin server can be changed, mitigating replay and other attacks.

Periodically changing the surface of attack (e.g., the URL being returned to a client for a given web request) makes it more difficult for an attacker to, among other things, a) successfully reconnoiter a targeted site, and b) launch sustained application layer attacks such as DDoS (Distributed Denial of Service) attacks. (Hence, the name web application obfuscation.) The obfuscation approach may be applied to both highly dynamic or static web content. Once implemented, the URL links in pages returned to the browser (or other user agent) can be made to change, even when the content rendered in the browser appears the same. Human end users may not notice any changes, but malware will constantly be presented with unique URLs, significantly increasing the difficulty for an attacker to successful deploy a scripted attack.

A CDN, as modified by the teachings of this disclosure, provides a platform from which to implement URL obfuscation. A CDN content server sits in the middle of a communication path between a browser and a server. According to the teachings herein, the CDN can be viewed as a “good guy in the middle,” and that position allows the CDN to defend effectively against an array of attacks.

While a CDN provides an excellent platform from which to implement the teachings of this invention, the teachings herein are not limited to CDNs. Thus, in other aspects of the invention, a proxy server that is not in a CDN and that is modified with the teachings hereof may be placed downstream of a server or set of servers that provide content to requesting clients, e.g., effectively acting as a gateway. The content provider may operate both the proxy and the origin server(s). The proxy server obscures URLs as described herein, protecting the website and its users. Furthermore, in other aspects of the invention, an origin server itself may be modified in accordance with the teachings hereof by running a URL obfuscation process in conjunction with underlying web server functionality. In short, any content server may be used to implement the URL obfuscation techniques described herein, regardless of whether such content server is part of a CDN or operates as a proxy server.

In light of the foregoing, a variety of methods, systems, and apparatus for obscuring URLs are described throughout this disclosure. By way of illustration only, in one non-limiting aspect of the invention, a method operative at a content server involves receiving a request for content from a client, where the content includes a given URL. The content could be an HTML page with an embedded URL, for example. The method further includes replacing this first URL (also referred to as the “original URL”) with a second, different URL that includes an encrypted string that the client cannot decrypt (also referred to as the “alternate URL”), so as to prevent the client from determining the original URL. Conventional encryption techniques can be used in this process; typically, the encryption is associated with an encryption key that the web server does not provide to the client. The encrypted string might represent, for example, an encrypted version of part or all of the original URL, although this is not necessary. The content, with the alternate URL, is sent to the client in response to the request.

The end user may make request for the content located at the alternate URL. If so, the content server receives a second request for content that is associated with the alternate URL, e.g., it may be an HTTP Get request for content identified by the alternate URL. The content server decrypts the encrypted string in the alternate URL, recovering the original URL. The original URL can be used to retrieve the content, either from internal cache or from an origin server.

The alternate URL is typically created by modifying the original URL, for example, by replacing pathname or other part of the original URL with the encrypted string. The encrypted string may be generated by encrypting that part of the original URL, or the entire original URL, or some other part of it, etc. In the majority of cases, the alternate URL will include the same protocol and hostname as the original URL, with some or all of the pathname having been replaced/obscured with the encrypted string.

In some implementations, the alternate URL may be valid to obtain content only for a limited period of time, such as a for a client session, or a configurable numerical time period. Requests associated with the alternate URL after expiry of the limited period of time may represent suspicious activity, leading the server to raise an alarm, log the event, ignore the request, or take other appropriate action, rather than serve the requested content.

As suggested above, a content server in a CDN is advantageously used to implement the foregoing method. While the key used to decrypt the alternate URL may not be available to the client, other content servers in the CDN can be equipped with the necessary keys to decrypt the alternate URL, in the event that the request for the alternate URL is directed to a content server other than the one that originally served the alternate URL.

In another aspect of the invention, an exemplary method involves a content server receiving a request for content (such as a web page) from a client, where the requested content including a URL (a first URL) that identifies content on an origin server. The content server obtains the content from the origin server, and replaces the first URL with a second, alternate URL. The alternate URL is invalid to obtain given content from the origin server. In other words, the origin server may return a ‘content not found’ or other error, or may ignore a request directed to the alternate URL, or may serve a redirect to a landing page or validation page like a login page. If the client requests content using the alternate URL, the content server can translate it back to the first URL in order to obtain the requested content (from internal cache or from an origin server, for instance).

As mentioned previously, the alternate URL may be encrypted, and may be valid for limited times, and so on.

In another aspect of the invention, a method of protecting a website involves receiving information that indicates a URL that is to be protected from attack/malware. Such configuration information may be submitted via a customer content provider portal and transmitted to web servers in a configuration file, which may be XML-based or utilize another syntax. A given content server protects the protected URL (a first URL) by rewriting it with a second, different URL (thus creating an alternate URL) that includes an encrypted string that the client cannot decrypt, so as to prevent the client from determining the protected URL. This may be done once a client requests content that includes the protected URL (i.e., at the time it needs to be sent to the client), or beforehand. As noted, the content server may need to retrieve the requested content from an origin server—in which case, the URL modification may be done at that retrieval time.

Further, the content server may receive a request from a client associated with the protected URL (that is, rather than the alternate URL)—which may indicate a suspicious request. If so, the content server can generate an alarm, log an alert, ignore the request, flag the request as suspicious, or take another configurable action.

In yet another aspect of the invention, a content server may periodically change URLs that it gives out and/or for which it will respond with the requested content. For example, the content server generally responds to requests made to a given first URL by sending the resource identified by that URL. However, after a certain event occurs, the server treats this first URL as invalid for obtaining content—perhaps returning an error like an HTTP 404 error, ignoring the request, serving a redirect to a landing page or validation page like a login page. Any of a wide range of events might trigger this behavior, including for example the end of a client session, the expiration of an amount of time as configured by a content owner, a change in client identity, a detection of a security threat (e.g., represented by the client's actions or otherwise) that is directed against the first URL or based on a pattern of client requests. For an implementation leveraging a CDN, content provider customers of the CDN can specify the triggering event via a customer portal on a content provider by content provider, site by site, or even a URL by URL basis.

As the first URL is treated as invalid, the content server instead responds to client requests made to second, different URL. This second URL refers to the same resource as the prior URL but it is different from the prior URL.

The event that triggers the content server to treat the first URL as invalid can be a configurable option. For example, as noted above, the content server may be a content server in a CDN that delivers content on behalf of participating content providers. In such an implementation, a given content provider may be able to specify the particular event that will trigger expiry of its URLs. This configuration information can be incorporated into a metadata configuration file that is transmitted to the content server and which the content server applies when responding to a given client request.

While the foregoing description has focused on exemplary methods for illustrative purposes, those skilled in the art will understand that various computer system and computer apparatus can be specifically adapted into special-purpose machines and used to implement the teachings disclosed herein.

### BRIEF DESCRIPTION OF THE DRAWINGS

The invention will be more fully understood from the following detailed description taken in conjunction with the accompanying drawings, in which:

FIG. 1 is a schematic view of one embodiment of a content delivery network;

FIG. 2 is a schematic view of one embodiment of a computing machine for use in the content delivery network shown in FIG. 1;

FIG. 3 is a diagram illustrating the flow of information in one embodiment of a URL obfuscation approach for protecting websites and website users;

FIG. 4 is a flow diagram illustrating exemplary steps for processing a request for content at a given URL;

FIG. 5 is a flow diagram illustrating exemplary steps for encrypting a protected URL; and,

FIG. 6 is block diagram showing an exemplary computer system in which the methods and apparatus disclosed herein may be implemented.

### DETAILED DESCRIPTION

The following description sets forth embodiments to provide an overall understanding of the principles of the structure, function, manufacture, and use of the methods and apparatus disclosed herein. The methods and apparatus described herein and illustrated in the accompanying drawings are non-limiting examples; the scope of the present invention is defined solely by the claims. The features described or illustrated in connection with one exemplary embodiment may be combined with the features of other embodiments. Such modifications and variations are intended to be included within the scope of the present invention. All patents, publications and references cited herein are expressly incorporated herein by reference in their entirety.

Throughout this disclosure, the term URL is used to refer to uniform resource locators. As those skilled in the art will recognize, a given URL may contain several components, including a protocol (also referred to as a scheme), a hostname, a path (which may include a filename, if the URL is pointing to a particular file/resource rather than a directory), a query (e.g., a query string with query parameters), and a fragment. Thus a model URL may be written as <protocol>://<hostname>/<path><query><fragment>. This model URL is typically referred to as an absolute URL. In some cases, web content may include links using relative URLs, which locate a resource relative to a base location (the base location being the page in which the URL appears). Hence, an exemplary relative URL may omit the protocol and hostname and may include only the path, query, and/or fragment. In this disclosure, the term URL is used to refer to both absolute URLs and relative URLs (i.e., non-fully-qualified URLs).

As a URL may be used with any of a variety of protocols, it follows that the teachings apply not just to websites running HTTP but to the use of URLs in other network content delivery schemes, such as FTP.

Content Delivery Networks

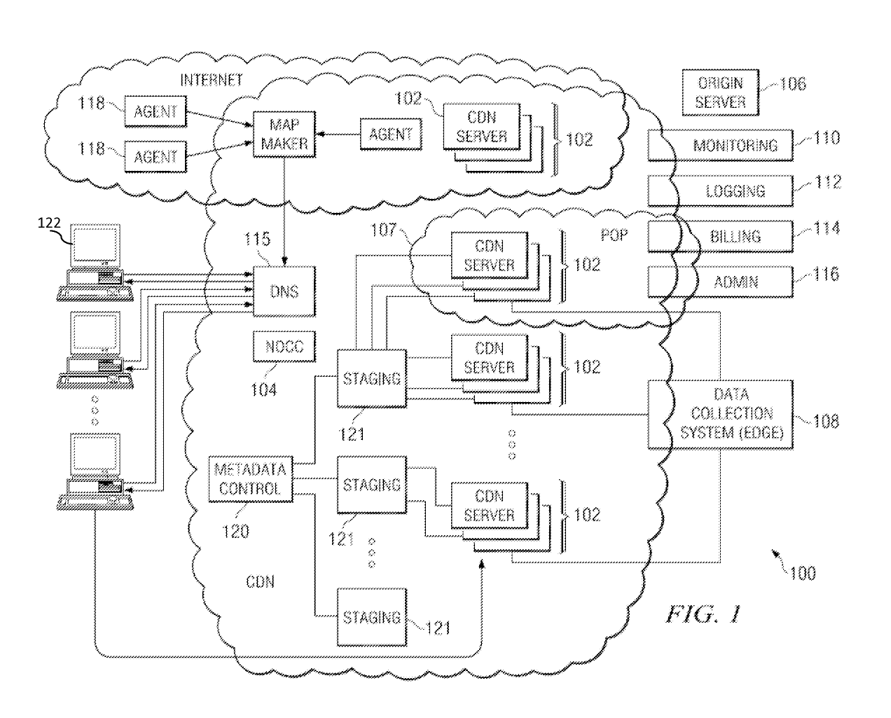

The teachings herein may be implemented in a CDN. In a known system, such as that shown in FIG. 1, a distributed computer system 100 is configured as a CDN and is assumed to have a set of machines 102a-n distributed around the Internet. Typically, most of the machines are servers located near the edge of the Internet, i.e., at or adjacent end user access networks. A network operations command center (NOCC) 104 manages operations of the various machines in the system. Third party sites, such as web site 106, offload delivery of content (e.g., HTML, embedded page objects, streaming media, software downloads, and the like) to the distributed computer system 100 and, in particular, to content servers (sometimes referred to as “edge” servers in light of their location near the “edges” of the Internet). Typically, content providers offload their content delivery by aliasing (e.g., by a DNS CNAME) given content provider domains or sub-domains to domains that are managed by the service provider's authoritative domain name service. End users that desire the content are directed to the distributed computer system to obtain that content more reliably and efficiently. Although not shown in detail, the distributed computer system may also include other infrastructure, such as a distributed data collection system 108 that collects usage and other data from the edge servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the edge servers.

More detail about CDN operation can be found in U.S. Pat. Nos. 7,293,093 and 7,693,959, the disclosures of which are incorporated by reference.

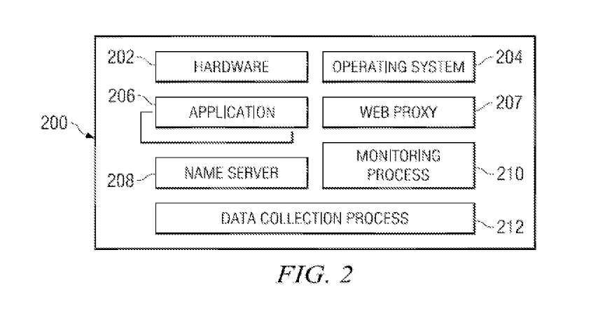

As illustrated in FIG. 2, a given machine 200 comprises commodity hardware (e.g., an Intel Pentium processor) 202 running an operating system kernel (such as Linux or variant) 204 that supports one or more applications 206a-n. To facilitate content delivery services, for example, given machines typically run a set of applications, such as an HTTP web proxy 207 (sometimes referred to as a “global host” or “ghost” process), a name server 208, a local monitoring process 210, a distributed data collection process 212, and the like. For streaming media, the machine typically includes one or more media servers, such as a Windows Media Server (WMS) or Flash server, as required by the supported media formats.

A CDN content server is configured to provide one or more extended content delivery features, preferably on a domain-specific, customer-specific basis, and preferably using configuration files that are distributed to the content servers using a configuration system. A given configuration file preferably is XML-based and includes a set of content handling rules and directives that facilitate one or more advanced content handling features. The configuration file may be delivered to the CDN content server via the data transport mechanism. U.S. Pat. No. 7,111,057 (the disclosure of which is hereby incorporated by reference) illustrates a useful infrastructure for delivering and managing content server content control information, and this and other content server control information can be provisioned by the CDN service provider itself, or (via an extranet or the like) the content provider customer who operates the origin server.

The CDN may include a storage subsystem, such as described in U.S. Pat. No. 7,472,178, the disclosure of which is incorporated herein by reference.

The CDN may operate a server cache hierarchy to provide intermediate caching of customer content; one such cache hierarchy subsystem is described in U.S. Pat. No. 7,376,716, the disclosure of which is incorporated herein by reference.

The CDN may provide secure content delivery among a client browser, edge server and customer origin server in the manner described in U.S. Publication No. 2004/0093419, the disclosure of which is incorporated herein by reference. Secure content delivery as described therein enforces SSL-based links between the client and the content server process, on the one hand, and between the content server process and an origin server process, on the other hand. This enables an SSL-protected web page and/or components thereof to be delivered via the edge server.

URL Obfuscation Overview

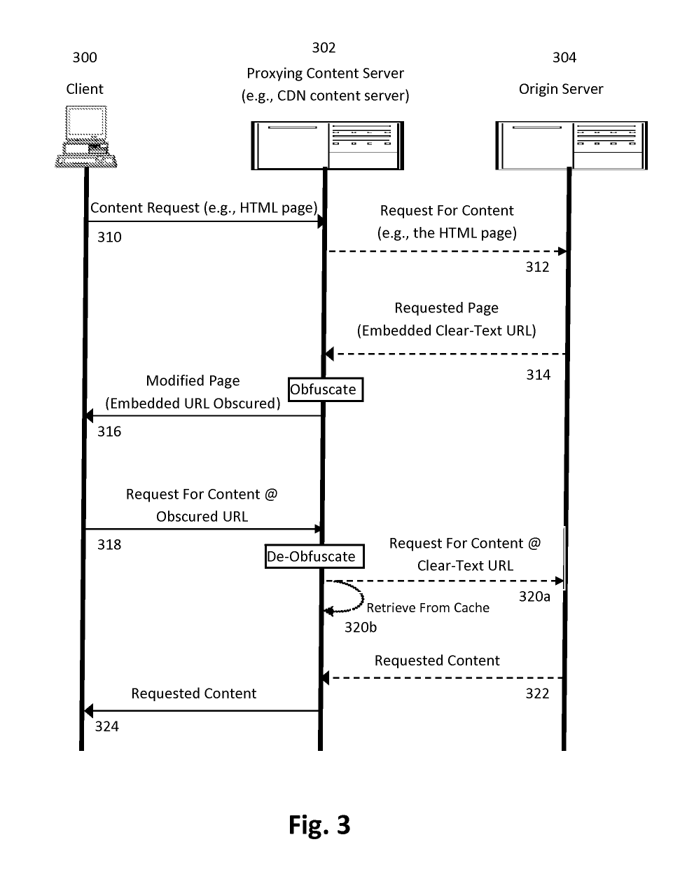

FIG. 3 illustrates an embodiment of a system for obscuring URLs. For convenience of description, FIG. 3 shows and the following describes a content server that acts as a proxy to an origin server. This is a particularly advantageous architecture, however as was noted earlier, the proxy approach is not limiting because the URL obfuscation functionality may be implemented within a standalone origin server, resulting in a single non-proxied content server architecture.

Generally, in the embodiment shown in FIG. 3, a content server 302 detects when a protected URL passes through, and rewrites that URL with an obfuscated value. Subsequent requests from the client browser back to the content server 302 for the obfuscated URL are then translated back into the original URL format, and the content server 302 goes forward to origin requesting the original URL. In this way, the original URL is not visible to the client.

Turning to FIG. 3, the illustrated process begins at step 310, when a client 300 makes a request to content server 302. Assume the content server 302 is in a CDN. In such a case, the client typically will have been given the IP address of the particular content server by the DNS system of the CDN, as noted above and described in U.S. Pat. No. 6,108,703, the teachings of which are incorporated herein by reference.

Assume that the request is for an HTML homepage of a website of a CDN customer, e.g., located at http://www.customer.com/. If the content server 302 is configured as a caching server, it may check its cache and if the content is found and not stale (e.g., the TTL has not expired) serve the HTML page from the cache. Otherwise, the content server 302 makes a request to the customer origin server 304 for the content (step 312, shown in dotted line since its occurrence depends on whether the proxy server 304 is able to serve the content from cache).

In step 314, the origin server 304 responds to the content server's request with the HTML page. At this point, assume that the content server 302 detects that the page contains one or more embedded URLs that have been designated as “protected” by the content provider. Such protected URLs might be designated individually or by a partial pathname match, e.g., every URL under www.customer.com/directory/*, where the symbol “*” designates a wildcard operator. The content server 302 replaces part or all of these URLs with a URL containing an obscured value and then serves the modified page to the client 300. For example, the original page may contain a link in clear text, such as http://www.customer.com/directory/login.html, representing that the customer's homepage contains a link to an account login page. That URL is what would appear to the client without obfuscation in place. However, after being modified by the content server 302, that client's request returns an obfuscated URL link, such as http://www.customer.com/Ad5698cB23Tgh9, shown at step 316. Here, the entire pathname, including the object name (login.html) in the URL has been obfuscated with an encrypted string, while the hostname remains in clear-text. In other cases, of course, the obfuscation could be configured such that only some part of the pathname is obfuscated.

Subsequently, the client 300 requests the object at an obfuscated URL (step 318). Upon receiving this request, the content server 302 reverses the encryption to recover the original, clear-text URL, and serves the requested content from cache or retrieves it from the origin server 304, as indicated in steps 320a, 320b, 322, and 324. Preferably, other servers in the CDN would be able to reverse the encryption too were the request for the obfuscated URL made to them, which will be explained in more detail below.

In one embodiment, the obfuscated URL can be tied to the specific user agent session of the client 300 with the content server 302 (e.g., a given client HTTP session). Once that session times out, that obfuscated URL link could change again. The content server 302 would modify the URL for the link to http://www.customer.com/directory/login.html to be http://www.customer.com/fAz3698gh8741Tpm6 and the former obfuscated URL would become invalid for requests. Such a technique makes reconnaissance against the site difficult for an attacker because each request requires a timed session with the content server, and every request could return different obfuscations for the same URL. Further, the URL obfuscation at the content server 302 can also be tied to a timed window.

To illustrate how the session time out and the timed window might be done consider the following example. As illustrated above in FIG. 3, a content server parses files of content type text/html looking for an instance of one of the origin server's protected URLs, say http://www.customer.com/directory/login.html. When a match is found, the protected URL is replaced with an obfuscated URL with reversible encryption using a per-customer secret key, a network-wide secret, an end user nonce and a time quantile. The end-user-nonce makes the set of obfuscated URLs unique to any given end user or set of users as desired, while the time quantile flushes the obfuscated URLs after some time. The end-user nonce can be carried in the URL or conveyed in a cookie value, like userid or sessionid, to cause obfuscated URLs to expire with the expiry of the end user session. The time quantile can be configurable and communicated to a content server via a metadata configuration file.

As can be seen from FIG. 3, the origin server operator (e.g., the content providers/customers of the CDN) may see little or no additional complexity for operations or development teams to consider at the origin server 304, since the obfuscation can be encapsulated in the content server 302 and not reach back to the web application itself on the origin server 304.

A content server also might be enabled to detect a client request for a protected URL that has not been obfuscated and provide notice of this request. This feature can be configurable as to how such requests are to be handled. Among the possible options: an error can be returned; the request can be logged for alert or other purpose; the request can still be forwarded by the content server to the origin server, but with a specific additional HTTP header to identify this as a suspicious request; the request can be dropped or redirected to an alternate origin server; a redirect to a given page such as a login page can be delivered; or a specific error page can be served. The origin server can also be configured to respond only to requests from designated servers, which—to continue the foregoing example—may be a set of CDN servers providing the obfuscation service to the origin server customer.

System Level Design

In one embodiment, the mechanism to obfuscate URLs is implemented as salted, time-bounded encryption by proxying content servers. In particular, a content server can include a obfuscation module, which is configured as software module executed by a processor in the server machine. For example, the module may be integrated with or otherwise associated with the proxy 207 shown in the CDN content server of FIG. 2. In some embodiments, the module is part of the proxy, although this is not necessary to implement the obfuscation functionality.

In this embodiment, the obfuscation system operates on a content server according to the following high level approach.
The site is configured for URL obfuscation by designating certain URLs as “entrance pages”. An entrance page may be the homepage of a particular site, e.g., a default page indicated by index.html, or otherwise. All entrance pages are preferably cacheable and searchable. One entrance page may be defined as the default page for unrecoverable URLs (if the encryption on a URL cannot be reversed, the client can be directed to the default page).
Identify a root url prefix which a customer may not use. This prefix defines the boundary of the protected, encoded URL space, e.g., as in <protocol>://<hostname>/PREFIX/. Alternatively, for some implementations, a set of protected URLs can be defined individually. Identifying specific URLs may be feasible if the number of protected URLs is relatively small and well-defined and the site structure is relatively static.
Every site can have a site secret that is unique across sites and known-only-to-the-content-servers.
There also exists a CDN network-wide secret.
Valid user sessions have a session identifier, perhaps stored in a cookie. Sessions have an expiration time; this expiration time defines the time quantile for the URLs. User agents that are configured not to accept cookies may be prevented from using origin server resources and delivered static (cacheable) resources only. Alternatively, the session ID may be placed in a cleartext portion of the URL for cookieless clients.

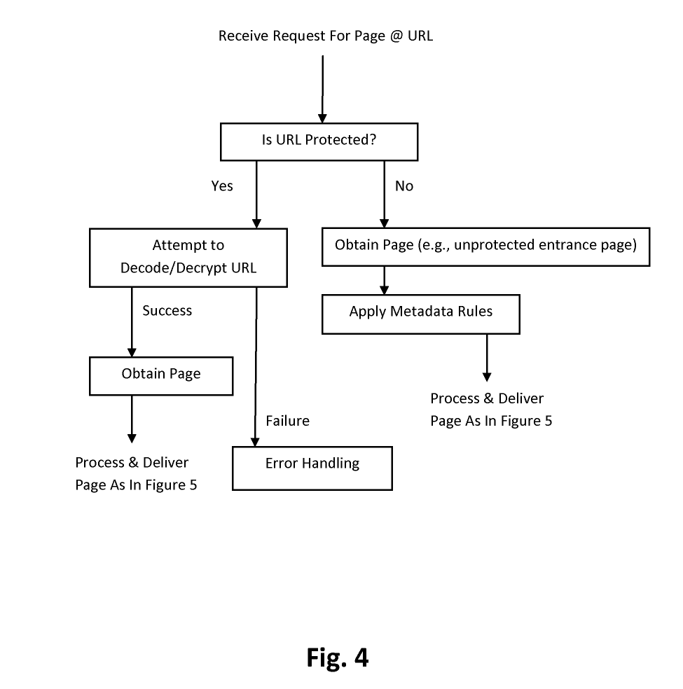

Turning to FIG. 4, when receiving a URL request from a user, the content server can determine what kind of page the request is for.

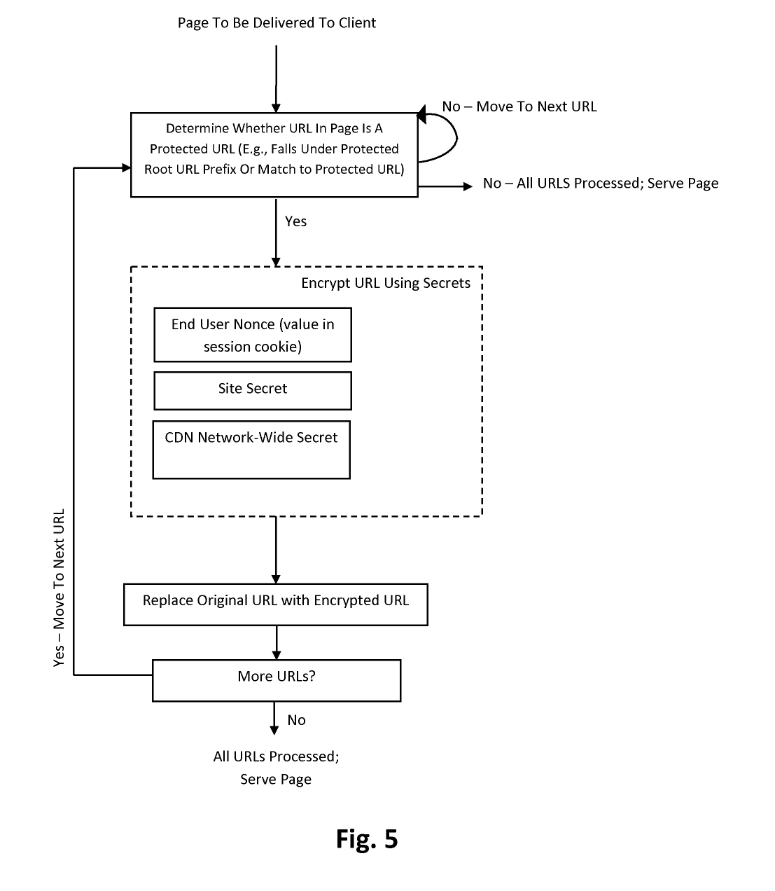

If it is a request for an unprotected entrance page, obtain the page from cache or from the origin server. Deliver the page according to content provider specific (or site specific) metadata rules and according to the process described in connection with FIG. 5, which illustrates encrypting protected links in the page.

If the request is for a protected URL (under /PREFIX), attempt to reverse the encoding and encryption applied to the URL to recover the original URL. If successful, obtain the page referred to by the URL, and deliver the page accordance with the process described in connection with FIG. 5, which illustrates the process of encrypting embedded links.

If unsuccessful, the content server can record an error and deliver a HTTP 404 Not Found page or a 302 Redirect to the default page. The server can deliver a customized 404 page explaining the error and suggesting an alternative course of action (e.g., to click on one of the entrance pages).

Turning to FIG. 5, when delivering a requested page to a client, the content server determines the user session ID. The content server also determines the site secret. Links on the requested page may now be encrypted to a key generated from session ID, site secret, and CDN network-wide secret and encoded: <protocol>://<site>/PREFIX/<encrypted string>. The modified page can then be served to the client.

If the requested URL refers to a protected page, then for additional protection identity proofing can be leveraged to validate that the user has rights to access sensitive pages on the site. For example, to view a bank account or to search a product database may require a user to login. The identity proof can be extracted from information in a request header (such as a cookie) to establish permission to deliver it to the client. This may be done before the page is parsed to look for protected URLs to encrypt. If the identity is not proven the content server returns a redirect to an authentication URL. The authentication system preferably has resources to defend against a having to deny service to valid users if it is under heavy attack, e.g., by a DDOS attack.

It should be noted that the foregoing assumes that the protected URLs refer to pages (e.g., HTML pages) for convenience of illustration only. However, the protected URLs may in fact reference other types of content and resources, such as images, other multimedia, interactive content, or web applications. For example, in FIG. 4, the protected URL may be decoded/decrypted to obtain a URL referring to an image, which is then obtained and served to the client. The process shown in FIG. 5 would be omitted in those cases where parsing the object to modify embedded links is not appropriate or possible.

Content Server Design

Generally, in this embodiment, when a content server receives a request it consults a content-provider-specific metadata configuration file to determine which features to apply to that request. The configuration options can be implemented to allow the proxy server to match requests by URL and apply obfuscation and de-obfuscation features and to determine the setting of variables on a per content-provider/customer basis. The configuration options may specify that only the filename and extension (and optionally a query string) be obscured, or they may instruct the proxy server to obscure the full path, and so on. The encryption algorithm (cipher) and key may be identified by configuration options.

If URL obfuscation is enabled for a given HTML content page, the content server parses the page, identifies the embedded resources that are to be obscured, modifies each one in place using reversible encryption, and emits the resulting page. Resources to be obscured are identified by configuration options, and may include HTML tags like “img src”, “a href”, and so forth.

Presented below is an exemplary obfuscation algorithm which uses symmetric-key encryption and URL encoding to create a valid URL string. A de-obfuscation algorithm reverses the process. Note that a given implementation may not involve every element below.

Exemplary obfuscation algorithm:

Eᵤᵣₗ=URL_ENCODE(hextime+nonce+special_char+CIPHER(HMAC(KeyCDN,KeyCust+hextime+nonce+hostname),target-url))

Where from right to left the values are:
target-url: the target uniform resource locator to be obscured
hostname: the hostname to which this obfuscated URL applies (e.g., a content provider hostname)
nonce: a per-user or per-session value to limit URL duplication and lifetime
hextime: the current epoch time (e.g., in unit of time such as minutes or seconds) expressed as hex digits or other encoding
KeyCust: a per-site unique value determined through a customer's configuration (alternatively, could be per-customer unique value)
KeyCDN: a network-wide key
HMAC: A Keyed-Hash Message Authentication Code, which may use a hash function such as MD5 or SHA-1.
CIPHER: an encryption cipher algorithm, such as DES, 3DES, or AES
URL_ENCODE: a percent encoding function (e.g., as specified by IETF RFC 3986, to substitute hexadecimal or other acceptable values for reserved characters)
Eᵤᵣₗ: the obfuscated uniform resource locator

The exemplary algorithm presented above uses a CDN network key to create an HMAC of the content-provider key, current time, end user nonce, and hostname. The HMAC output is used as a symmetric encryption key for the target-url. The resulting encrypted value (represented in base-64 notation for example) is appended to the clear text hextime and nonce values, with a special character separating the nonce from the cipher output.

It should be noted that while in this embodiment a special character is used to delineate the clear-text from the cipher, a variety of other delineation techniques/mechanisms could be used. For example, a string of characters could be used, or the cipher could be located in a given query string parameter or a URL parameter. The cipher text could also be located at a predetermined location, e.g., as a particular pathname component or directly following the hostname. Virtually any mechanism that allows one to differentiate the cipher from other components of the encoded string (the clear-text components) can be used. Moreover, the use of a specific one of such techniques, selected from amongst several, can itself be a configurable aspect of the system.

Configuration options may also specify how to determine the nonce. Preferably, it is a unique session identifier generated by the server at the time the end-user logs in to the system. As noted above, for example, it is stored in a session cookie or similar value such that URL lifetime is limited to the browser session lifetime. In some implementations, the content server may replace the leftmost nonce value (the one encoded in the URL but in clear text in the Eᵤᵣₗ) with an empty string to avoid exposure to the end user of their nonce value. Note that in such an implementation, the nonce value should be consistently presented to the content server in subsequent requests so that the content server can compute the correct HMAC value as a decryption key.

The CDN key is distributed to secure content servers in the network. The key may be given timestamps, lifetimes, and periodically rotated. Using the hextime value that was placed in the URL, a given content server can tell which CDN Key to use for decryption.

The KeyCust key may be specified in the configuration file in clear text or deployed via separate secure infrastructure. Preferably the KeyCust key is a site unique value, although the key could be made to be common across a given customer's sites (i.e., a per-customer key). As with the CDN key, the KeyCust may be given timestamps, lifetimes, and periodically rotated. The hextime value placed in the URL can be used to determine which KeyCust to use for decryption.

Note that the target-url may be an absolute URL or a relative URL. In the latter case, before encoding/encrypting, the relative URL is either converted into an absolute URL by combining it with the resource location information of its parent object (e.g., the HTML page), or it is encoded/encrypted using the relative URL string alone. The former approach avoids the need to parse a client request to a URL that has been resolved by a browser combining an encoded relative URL and a separately encoded base (parent) URL.

Exemplary de-obfuscation algorithm. In this implementation any content server in the CDN can de-obfuscate, taking the following values as input:
Eᵤᵣₗ: the obfuscated URI (Eᵤᵣₗ) from a client's HTTP request URL
nonce: the nonce from the end user session or URL, per the configuration
hextime: the epoch time at generation extracted from the Eᵤᵣₗ
KeyCust: the customer's key value
KeyCDN: the CDN network-wide key

Note that in the foregoing approach the de-obfuscation attempt will fail if the hextime is too far in the past, since the CDN key associated with that hextime will have expired. This and session (nonce) rollover together limit obscured URL replay attacks to not only a given user session but also a limited time period, irrespective of the session. The expiration time for the timestamp of the hextime can be a configuration option. The expiration time affects the end user experience on a web site since it will cause requests to fail when an obscured URL is too old.

Continuing the current example, de-obfuscation uses a URL_DECODE function, the symmetric opposite of URL_ENCODE described above, and a TAIL operator that returns the substring of the Eᵤᵣₗ following the “special_char” special character in the decoded string. The TAIL substring returns the encrypted portion of the URL above. Taking these as input the target-url can be computed as follows:

target-url=URL_DECODE(CIPHER(HMAC(KeyCDN,KeyCust+hextime+nonce+hostname),TAIL(Eᵤᵣₗ)))

Once decoded the target-url and obscured URL are both held in memory for use in content server match rules, which may drive other CDN functionality and behavior. The Eᵤᵣₗ is also available for matching using a match selector.

Note that the nonce computation method cannot be changed without affecting current URLs; a change to the method requires browser sessions to be renewed.

Configuration Management

A variety of system features are configurable. Configuration options can be transmitted to a CDN by a given content provider through a configuration portal application provided by the CDN. Customer provided and other (internal) configuration options can be set using metadata distributed to content servers. The options use the capability of matching on a request URL by hostname, path, filename, extension, and other attributes. Within the match context, obfuscation can be enabled for text/html objects. The parameters are also specified in configuration elements. The following provides some example elements.

| Tag Element | Input Type | Description |
|---|---|---|
| Tag_1 | [on\|off] | Defines if WAO is enabled for this content |
| Tag_2 | string | The site path prefix reserved for WAO |
| Tag_3 | deltaTime | Maximum validity interval of the hextime timestamp in an |
| | | obfuscated URL |
| Tag_4 | string | Specifies to extract the nonce value from a cookie of the |
| | | given name |
| Tag_5 | Symmetric | The security cipher to use to encrypt and decrypt URLs |
| | Cipher | |
| Tag_6 | Customer | A clear text value identifier containing the customer |
| | Encryption Key | content provider's HMAC key |
| Tag_7 | [off\| | Determines what level of WAO is required for URLs in |
| | warn\|strict] | this context: strict means requests for non-obfuscated |
| | | URLs will fail; warn causes the edge server to log an alert |
| | | but allow the request; off means clear text URLs are |
| | | allowed through without an alert |
| Tag_8 | [404\|302] | The HTTP response status code returned in case of a strict |
| | | check failure |
| Tag_9 | URL | Custom error page that will be returned by the edge server |
| | | in case of a strict check failure |
| Tag_10 | [on\|off] | Determines if WAO feature will obfuscate URLs in HTML |
| | | content |
| Tag_11 | [a-href\|link-href\| | The tags whose values are obfuscated by the WAO |
| | img-src\|link-src\| | processor |
| | script-src] | |

For more information about configuration and delivering metadata options and rules, see e.g., U.S. Pat. Nos. 7,240,100 and 7,111,057, the disclosures of which are hereby incorporated by reference in their entireties.

Attack Evolution

Attacks on web sites will continue to evolve. In further embodiments, other kinds of attacks can be addressed by modifying and obscuring form field names, object classes (such as in HTML div tags), and the page DOM tree structure. For example, the content server proxy (or associated software) may dynamically alter POST field names to obscure the desired information sought by malware. This technique is advantageous for defending against an attacker who tries to access the Document Object Module (DOM) tree in order to tell if a POST has the parameter they are interested in.

Even if an attacker is able to spider through a site, URL obfuscation can be implemented on the site such that an attack must enter at designated entrance pages and traverse obscured URLs in a particular request sequence, since the target URL is unpredictable otherwise. This provides an opportunity to differentiate human request behavior from that of a spider or bot (e.g., via behavioral analytics that examine information such as the sequence of URLs requested, the time between URL requests, patterns in URL requests, and so on) and layer in further identity proofing or other defensive maneuvers.

Furthermore, in some embodiments, the rewriting/encrypting of URLs can be accompanied by the deployment of decoys into pages as hidden links. They would not be visible to normal end users but bots may follow them. As with the results of behavioral analytics, requests for decoy objects can identify user agents or devices that are accessing content they should not be accessing. The system can then automatically raise alerts and potentially quarantine the bad user agent.

Exemplary Applications

The teachings herein can be used in a variety of circumstances and to address a range of security threats. Several example use cases are presented below to illustrate their value and flexibility. They should not be viewed as limiting or necessary to the practice of the subject matter disclosed herein.

DDoS Attacks. Fixed-URL distributed denial of service (DDoS) attacks generate load to an origin database or application server. These attacks may be coordinated with existing botnet command and control systems. URL obfuscation techniques can address these attacks by ensuring only recently-generated URLs are allowed to access origin infrastructure. Requests for other URLs may be discarded or dealt with by the content server. Because the content server can be part of a CDN or other distributed network of servers that is scaled to handle these increased loads, such attacks can be mitigated.

MITB Attacks. URL obfuscation techniques also can address Man-in-the-Browser (MITB) attacks that leverage a software plug-in that watch for known URLs and then take action, such as transferring funds from a victim's bank account, or recording keystrokes. A content server modified in accordance with this disclosure can defend against such attacks.

URL obfuscation can protect specific URLs, as identified by content providers, from being targeted by an MITB attack. The capability detects when a protected URL passes through the proxy server, and rewrite that URL with an obfuscated value. Subsequent requests from the browser back to proxy for the obfuscated URL are then translated back into the original URL format, and the content server goes forward to origin requesting the protected URL. In this way, the protected URL is not visible to the browser and thus also is not visible to the man-in-the-browser. This means that an MITB attack is not triggered for the protected URL, because the protected URL is not seen in the browser. Further, each browser session may see a different random URL in place of the protected URL, hindering attempts to automate such, as there is no pattern that can be matched by the malicious browser extension. In short, by obscuring the target URL and periodically changing it, the malware plug-in can be prevented from recognizing the target pages (e.g., bank account pages, streaming multimedia endpoints, web service endpoints, or otherwise).

URL enumeration or predictable resource location attacks. URL obfuscation may be used to address enumeration or predictable resource location attacks that spider a site to harvest sensitive information embedded in the URL structure, such as catalog part numbers or flight numbers, application server session identifiers, user names or other resources. If a website allows username or other sensitive information to be specified in a URL and returns a different response for valid and invalid inputs, an attacker may attempt to guess at valid values and harvest information. A URL-obscuring content server, however, can modify URLs to look like random strings, revealing no information about site structure or resources to spiders or other automated user agents, and thus preventing them from obtaining information or conducting reconnaissance against the site.

URL-based attacks. In-URL cross-site scripting, SQL injection or input-validation attacks that allow sensitive information to be conveyed in the URL. This category may include input validation attacks like buffer overflow or canonicalization (e.g., use of “../” in the path to escape the web root). A content server that obscures URLs can defend against these attacks since the only valid URLs are those generated by the content server, under direction of the content provider's origin server. Other URLs, including those that have been manipulated by an attacker, can be rejected. Furthermore, requests made to protected URLs in clear-text that do not originate from a known content server can be rejected at the origin server.

Polymorphism

The periodic changing of the URL name space for a given website can be thought of as a type of URL polymorphism. In addition, some embodiments can utilize polymorphic hostnames to switch hostname (and optionally protection level) for some users. To utilize such a facility:
The content provider can publish multiple, e.g., hundreds or thousands, of DNS names.
The system providing URL obfuscation capabilities can associate different protection levels based on hostname.
All hostnames in an equivalence set will have or point to the same origin hostname of the content provider.
The system can make the main hostname unavailable for all but entrance pages.

Polymorphic hostnames used in such an approach are preferably in the same top level domain which is associated with the content provider.

Search Engines

In some embodiments, search engines can be blocked from protected (obscured) URLs, which will be of no use later anyway, because they will expire. A content server can match on search engine User-Agent strings and return a redirect or an error page to prevent indexing for such URLs.

Implementation with Computer Apparatus

The clients, servers, and other devices described herein may be implemented on conventional computer systems, as modified by the teachings hereof, with the functional characteristics described above realized in software, hardware, or a combination thereof.

Software may include one or several discrete programs. Any given function may comprise part of any given module, process, execution thread, or other such programming construct. Generalizing, each function described above may be implemented as computer code, namely, as a set of computer instructions, for performing the functionality described via execution of that code using conventional means, e.g., a processor, a computer, a machine, a system, digital data processing device, or other apparatus. In one embodiment, such software may be implemented in a programming language that runs in conjunction with a DNS-compliant name server (e.g., BIND).

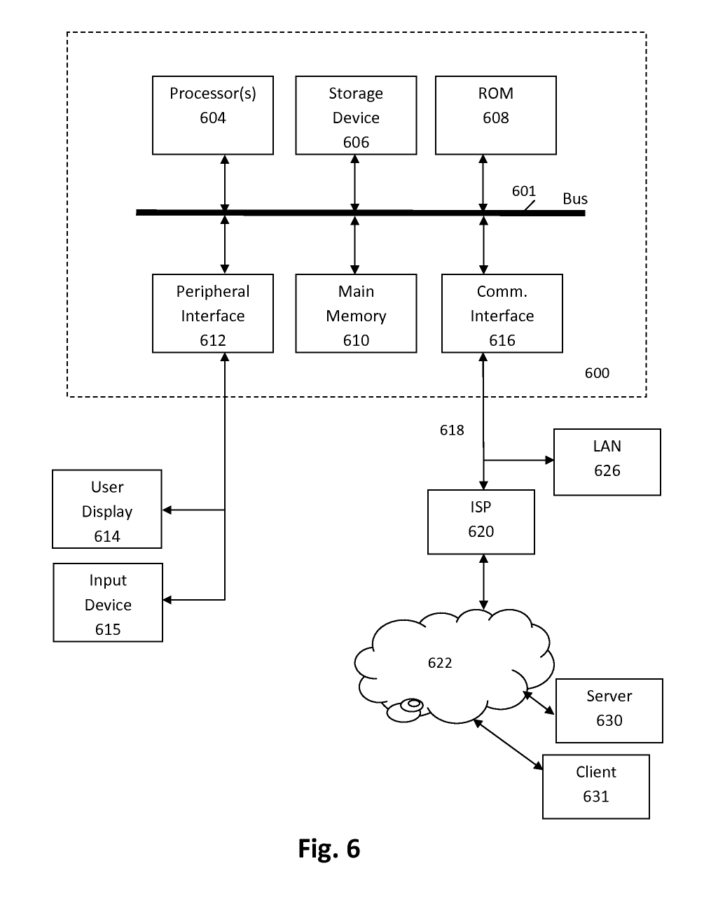

FIG. 6 is a block diagram that illustrates hardware in a computer system 600 upon which such software may run in order to implement embodiments of the invention. The computer system 600 may be embodied in a client device, server, personal computer, workstation, tablet computer, wireless device, mobile device, network device, router, hub, gateway, or other device.

Computer system 600 includes a processor 604 coupled to bus 601. In some systems, multiple processor and/or processor cores may be employed. Computer system 600 further includes a main memory 610, such as a random access memory (RAM) or other storage device, coupled to the bus 601 for storing information and instructions to be executed by processor 604. A read only memory (ROM) 608 is coupled to the bus 601 for storing information and instructions for processor 604. A non-volatile storage device 606, such as a magnetic disk, solid state memory (e.g., flash memory), or optical disk, is provided and coupled to bus 601 for storing information and instructions. Other application-specific integrated circuits (ASICs), field programmable gate arrays (FPGAs) or circuitry may be included in the computer system 600 to perform functions described herein.

A peripheral interface 612 communicatively couples computer system 600 to a user display 614 that displays the output of software executing on the computer system, and an input device 615 (e.g., a keyboard, mouse, trackpad, touchscreen) that communicates user input and instructions to the computer system 600. The peripheral interface 612 may include interface circuitry, control and/or level-shifting logic for local buses such as RS-485, Universal Serial Bus (USB), IEEE 1394, or other communication links.

Computer system 600 is coupled to a communication interface 616 that provides a link (e.g., at a physical layer, data link layer, or otherwise) between the system bus 601 and an external communication link. The communication interface 616 provides a network link 618. The communication interface 616 may represent a Ethernet or other network interface card (NIC), a wireless interface, modem, an optical interface, or other kind of input/output interface.

Network link 618 provides data communication through one or more networks to other devices. Such devices include other computer systems that are part of a local area network (LAN) 626. Furthermore, the network link 618 provides a link, via an internet service provider (ISP) 620, to the Internet 622. In turn, the Internet 622 may provide a link to other computing systems such as a remote server 630 and/or a remote client 631. Network link 618 and such networks may transmit data using packet-switched, circuit-switched, or other data-transmission approaches.

In operation, the computer system 600 may implement the functionality described herein as a result of the processor executing code. Such code is typically read from or provided by a non-transitory computer-readable medium, such as memory 610, ROM 608, or storage device 606. Other forms of non-transitory computer-readable media include disks, tapes, magnetic media, CD-ROMs, optical media, RAM, PROM, EPROM, and EEPROM. Any other non-transitory computer-readable medium may also be employed. Executing code may also be read from network link 618 (e.g., following temporary storage in an interface buffer, local memory, or other circuitry).

What is claimed is:

1. A computer-implemented method operative at a content server, comprising:
receiving from a client a request for content, the content including a first URL;
changing the first URL to a second URL that is different from the first URL and that includes an encrypted string that the client cannot decrypt, so as to prevent the client from determining the first URL;
sending the content, with the second URL, to the client in response to the request.

2. The method of claim 1, further comprising:
receiving from the client a second request for content, the second request being associated with the second URL;
recovering the first URL, said recovery comprising: decrypting the encrypted string in the second URL;
using the first URL to obtain the content sought by the second request;
sending the obtained content to the client in response to the second request for content.

3. The method of claim 1, wherein the content server is a proxy server that serves content on behalf of an origin server and the method further comprises:
prior to changing the first URL to the second URL, receiving the content that includes the first URL from the origin server.

4. The method of claim 1, wherein the content server is one of a plurality of content servers in a content delivery network that delivers content on behalf of participating content providers.

5. The method of claim 1, wherein the second URL is valid to obtain content from the content server only for a limited period of time.

6. The method of claim 5, wherein the content server is one of a plurality of content servers in a content delivery network that delivers content on behalf of participating content providers, and the limited period of time is an amount of time that is configurable on a content provider by content provider basis.

7. The method of claim 1, wherein the second URL is valid to obtain content from the content server only for a given client session.

8. The method of claim 7, wherein a request made to the second URL after the end of the given client session, or from a different client session, causes the content server to take an action selected from the group of actions that is: ignore the request, serve an error page, serve a redirect to a predetermined page, and serve a redirect to a login page.

9. The method of claim 1, wherein the first URL comprises a protocol, a host name, and a path.

10. The method of claim 1, wherein the content comprises a web page with the first URL embedded therein.

11. The method of claim 1, wherein the encrypted string is created by applying a cipher function to at least part of the first URL.

12. The method of claim 1, wherein the second URL is created by replacing at least part of a path of the first URL with the encrypted string.

13. The method of claim 1, wherein the second URL comprises (i) a same hostname as the first URL, and (ii) the encrypted string.

14. The method of claim 1, further comprising:
receiving a second content request from the client, or another client, where the second content request is associated with the first URL;
taking an action selected from the group of actions that is: generating an alarm, logging an alert, sending a notification of the request to an administrator, ignoring the request, serving an error page to the client, flagging the request as suspicious, serving a redirect to a predetermined page, and serving a redirect to a login page.

15. The method of claim 1, further comprising: receiving information indicating that the first URL is to be protected.

16. The method of claim 15, wherein the content server is one of a plurality of content servers in a content delivery network that delivers content on behalf of participating content providers, and wherein the information indicating the first URL should be protected is part of a configuration file for a given content provider whose content is located at the first URL.

17. (canceled)

18. The method of claim 15, wherein the information indicates that all URLs matching or partially matching a pathname are to be protected, and the first URL matches or partially matches the pathname.

19. An apparatus, comprising:
a content server having one or more processors and memory holding instructions that, when executed by the one or more processors, will cause the content server to:
receive, from a client device, a request for content, where the content includes a first URL;
change the first URL to a second URL that is different from the first URL and that includes an encrypted string that the client device cannot decrypt, so as to prevent the client device from determining the first URL;
send the content, with the second URL, to the client device in response to the request.

20. The apparatus of claim 19, wherein the execution of the instructions further will cause the content server to:
receive, from the client device, a second request for content, the second request being associated with the second URL;
recover the first URL, said recovery comprising: decrypting the encrypted string in the second URL;
use the first URL to obtain the content sought by the second request;
send the obtained content to the client device in response to the second request for content.

21. The apparatus of claim 19, wherein the content server is a proxy server that serves content on behalf of an origin server, and wherein content server receives the content that includes the first URL from the origin server, prior to changing the first URL to the second URL.

22. The apparatus of claim 19, wherein the content server is one of a plurality of content servers in a content delivery network that delivers content on behalf of participating content providers.

23. The apparatus of claim 19, wherein the content server treats the second URL as valid to obtain content from the at least one content server only for a limited period of time.

24. The apparatus of claim 23, wherein the content server is one of a plurality of content servers in a content delivery network that delivers content on behalf of participating content providers, and the limited period of time is an amount of time that is configurable on a content provider by content provider basis.

25. The apparatus of claim 24, wherein the content server treats the second URL as valid to obtain content from the content server only for a given client session.

26. The apparatus of claim 25, wherein a request made to the second URL after the end of the given client session, or from a different client session, causes the content server to take an action selected from the group of actions that is: ignore the request, serve an error page, serve a redirect to a predetermined page, and serve a redirect to a login page.

27. The apparatus of claim 19, wherein the first URL comprises a protocol, a host name, and a path.

28. The apparatus of claim 19, wherein the content comprises a web page with the first URL embedded therein.

29. The apparatus of claim 19, wherein the execution of the instructions further will cause the content server to create the encrypted string by applying a cipher function to at least part of the first URL.

30. The apparatus of claim 19, wherein the execution of the instructions further will cause the content server to create the second URL by replacing at least part of a path of the first URL with the encrypted string.

31. The apparatus of claim 19, wherein the second URL comprises (i) a same hostname as the first URL, and (ii) the encrypted string.

32. The apparatus of claim 19, wherein the execution of the instructions further will cause the content server to:
receive a second content request from the client device, or another client device, where the second content request is associated with the first URL;
take an action selected from the group of actions that is: generating an alarm, logging an alert, sending a notification of the request to an administrator, ignoring the request, serving an error page to the client device, flagging the request as suspicious, serving a redirect to a predetermined page, and serving a redirect to a login page.

33. The apparatus of claim 19, wherein the execution of the instructions further will cause the content server to receive information indicating that the first URL is to be protected.

34. The apparatus of claim 33, wherein the content server is one of a plurality of content servers in a content delivery network that delivers content on behalf of participating content providers, and wherein the information indicating the first URL should be protected is part of a configuration file for a given content provider whose content is located at the first URL.

35. (canceled)

36. The apparatus of claim 33, wherein the information indicates that all URLs matching or partially matching a pathname are to be protected, and the first URL matches or partially matches the pathname.

37-76. (canceled)

77. The method of claim 1, wherein the encrypted string in the second URL replaces a portion of the first URL, the second URL otherwise being the same as the first URL.

78. The apparatus of claim 19, wherein the encrypted string in the second URL replaces a portion of the first URL, the second URL otherwise being the same as the first URL.
